(19) United States
(12) Patent Application Publication
(10) Pub. No.: US 2013/0006704 A1
(43) Pub. Date: Jan. 3, 2013

(54) Method and System For Creating Customer Profiles

(75) Inventors: Ashwin RAVINDRAN, Morton, IL (US); Hariharan Kalahasty Iyer, Fort Collins, CO (US); Darrell Charles Samuels, New Orleans, LA (US); Andrea Lynne Grimm, East Peoria, IL (US); Johannes Martin Kahrs, Washington, IL (US); Sean Randolph Koors, Peoria, IL (US)

(73) Assignee: Caterpillar Inc.

(21) Appl. No.: 13/174,182

(22) Filed: Jun. 30, 2011

(51) Int. Cl. G06Q 10/00

(52) U.S. Cl. 705/7.29

(57) ABSTRACT

A system for creating a customer profile includes at t one computer system configured to retrieve first business information regarding a customer from at least one first database including data regarding machine transactions. The at least one computer system is further configured to retrieve second business information regarding the customer from at least one second database including data regarding construction projects, retrieve third business information regarding the customer from at least one third database including data regarding fleet composition, and create a profile of the customer based on the retrieved first, second, and third business information.

### TECHNICAL FIELD

The present disclosure relates generally to a method and system for processing customer information, and more particularly, to a method and system for creating customer profiles based on customer information.

### BACKGROUND

Customers may use different types of machines, e.g., trucks, loader, excavators, e for projects of different scales. Depending on a customer's business activities and plans, the customer's spending on machines and services may fluctuate over time. A sales organization create customer profiles in order to analyze a customer's spending behavior. For example, the sales organization may create customer profiles that report the customer's most recent business dealings.

Many systems and methodologies are developed to manage data related to customers and customer profiles. One approach relating to household consumers is described in U.S. Pat. No. 6,298,348 to Elderling (“the '348 patent”). The '348 patent describes creating profiles of household consumers in order to target advertisements that are specific to the respective consumers' preferences. The consumer profiles describe the consumer based on demographic characteristics and product preferences. The consumer profiles are based on information regarding consumers' past spending records for groceries and a set of heuristic rules for characterizing the consumer as a result of their past spending records.

The consumer profiles described in the '348 patent, however, may not take into account various other factors, such as factors and activities specific to the machine manufacturing industry or similar industries. Therefore, the consumer profile may be incomplete and ineffective for use in this industry or similar industries.

The disclosed system is directed to overcoming one or more of the problems set forth above.

### SUMMARY

In one aspect, the present disclosure is directed to a system for creating a customer profile. The system includes at least one computer system configured to retrieve first business information regarding a customer from at least one first database including data regarding machine transactions. The at least one computer system is further configured to retrieve second business information regarding the customer from at least one second database including data regarding construction projects, retrieve third business information regarding the customer from at least one third database including data regarding fleet composition, and create a profile of the customer based on the retrieved first, second, and third business information.

In another aspect, the present disclosure is directed to a method for creating a customer profile using at least one computer system. The method includes retrieving, using the at least one computer system, first business information regarding a customer from at least one first database including data regarding machine transactions. The method also includes retrieving, using the at least one computer system, second business information regarding the customer from at least one second database including data regarding construction projects, and retrieving, using the at least one computer system, third business information regarding the customer from at least one third database including data regarding fleet composition. The method further includes creating, using the at least one computer system, the profile of the customer based on the retrieved first, second, and third business information.

In a further aspect, the present disclosure is directed to a non-transitory computer readable medium for use on at least one computer system containing computer-executable programming instructions for performing a method for creating a customer profile. The method includes retrieving business information regarding a customer from at least one database including at least one of data regarding machine transactions, data regarding construction projects, or data regarding fleet composition. The method also includes evaluating the retrieved business information based on at least one business metric and assigning at least one indicator to the customer based on the evaluation. The method further includes predicting a future transaction by the customer based on the determined business information and creating the profile of the customer based on the determined business information, the at least one indicator, and the predicted future transaction.

### BRIEF DESCRIPTION OF THE DRAWINGS

FIG. 1 is a diagrammatic illustration of a system for creating customer profiles, according to an exemplary embodiment;

FIG. 2 is a flow chart illustrating a method for creating customer profiles, according to an exemplary embodiment; and

FIG. 3 shows a customer profile, according to an exemplary embodiment.

### DETAILED DESCRIPTION

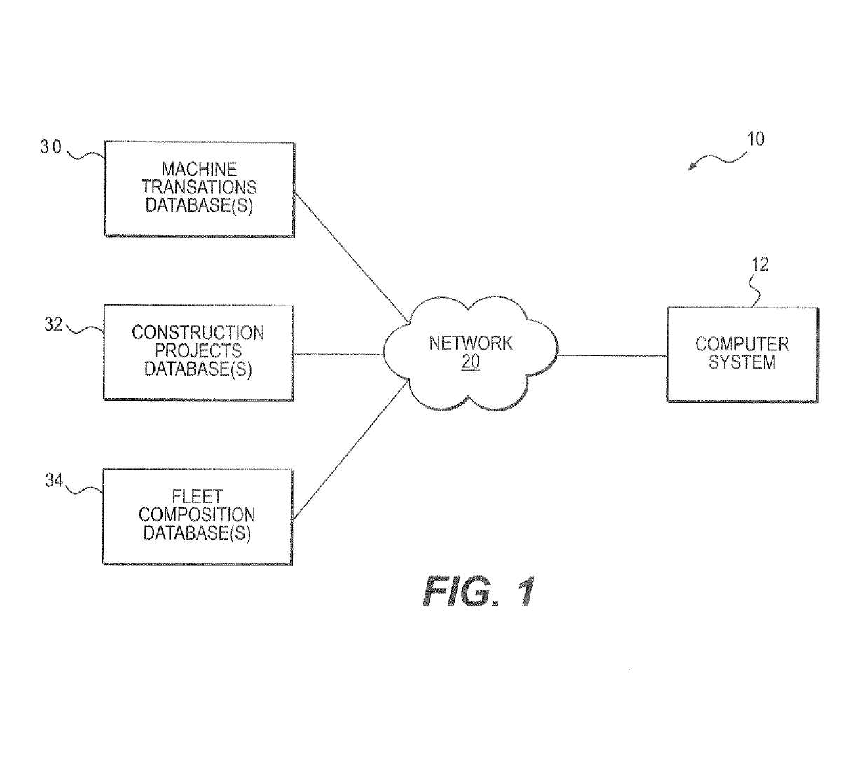

FIG. 1 illustrates an exemplary system 10 for creating customer profiles according to an exemplary embodiment. A customer profile may include data related to business transactions between a customer and other entities. The system 10 may include one or more computer systems 12 (or other hardware) or software applications (or other software) executed by one or more processors configured to perform certain functions related to creation of customer profiles, such as generating, maintaining, updating, deleting, and/or presenting customer profiles. These computer systems may each include a memory, a processor, and a display for presenting one or more maps, graphs, messages, etc., consistent with certain disclosed embodiments.

The computer system 12 may be connected, e.g., via a network 20, to a plurality of databases, such as one or more machine transactions databases 30, one or more construction projects databases 32, one or more fleet composition databases 34, etc. The network 20 may be any type of wireline or wireless communication network for exchanging or delivering information or signals, such as the Internet, a wireless local area network (LAN), or any other network. Thus, the network 20 may be any type of communications system known in the art.

The computer system 12 may include one or more processors, a memory, a transceiver device, and a display device. The display device may include one or more monitors (e.g., a liquid crystal display (LCD), a cathode ray tube (CRT), a personal digital assistant (PDA), a plasma display, a touch-screen, a portable hand-held device, or any such display device known in the art) configured to actively and responsively display information to a user, such as a manufacturer, dealer, or any other entity.

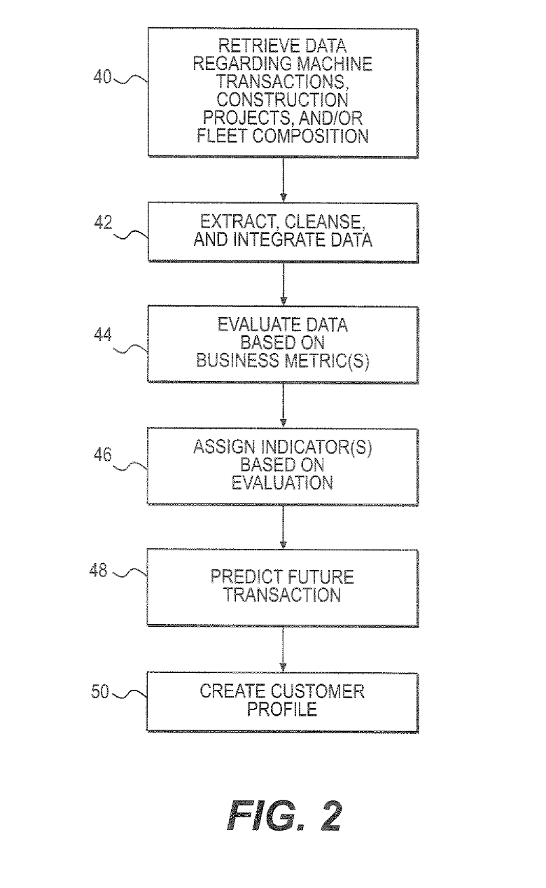

The transceiver device may include one or more devices that transmit and receive data, such as data processed by the processor and/or stored by the memory. The memory may be configured to store information used by the processor, e.g., computer programs or code used by the processor to enable the processor to perform functions consistent with disclosed embodiments, e.g., the processes described with regard to FIG. 2 discussed in detail below. The memory may include one or more memory devices including, but not limited to, a storage medium such as a read-only memory (ROM), a flash memory, a dynamic or static random access memory (RAM), a hard disk device, an optical disk device, etc.

The processor may be configured to receive data, e.g., from the databases 30, 32, 34, and process information stored in the memory. The processor may be configured with different types of hardware and/or software (e.g., a microprocessor, a gateway, a product link device, a communication adapter, etc.). Further, the processor may execute software for performing one or more functions consistent with the disclosed embodiments. The processor may include any appropriate type of general purpose microprocessor, digital signal processor, or microcontroller.

The machine transactions database 30 may include data regarding machine transactions (e.g., completed transactions, pending transactions, orders, etc.). For example, the data regarding machine transactions may include invoice information (e.g., any information typically included in an invoice) and other information regarding machine transactions. The information may include, e.g., identifying information regarding the services, machines, or parts involved in the transaction, such as the machine manufacturer, model, etc.; whether the machines or parts are new or used; the customer, dealer, owner, or other parties involved in the transaction acting as buyer, seller, lessor, lessee, etc.; financial information associated with the transaction; the date of the transaction; etc. Thus, the machine transactions database 30 may identify current and/or prior customers based on the entities identified in the machine transactions database 30, e.g., as buyers, sellers, lessors, lessees, etc.

The term “dealer” may refer to an entity that performs service on machines, sells machines or parts, and/or provides leases on machines. The term “customer” may refer to an entity that receives or orders service on machines, buys machines or parts, and/or obtains leases on machines. The term “business transaction” or “machine transaction” may refer to a sale, lease (or rental), and/or service of a machine or part thereof, or other exchange of items of value, such as information, goods, services, and money.

The term “part” may refer to a portion into which a product is divided. In the exemplary embodiment, the product may be a machine, such as a vehicle, or other equipment including a plurality of parts, such as an engine, fuel system, tires, a transmission, or any other component or subsystem. It is understood, however, that the product may be another manufactured item that includes a plurality of parts.

In an exemplary embodiment, the data regarding machine transactions may be provided to the machine transactions database 30 by the dealers handling the machine transactions. The machine transactions database 30 may include a dealer business systems (DBS) database, which may he a dealer-owned and/or dealer-operated database including information input from a plurality of dealers, such as data on the buyer, seller, lessor, lessee, manufacturer, date sold/leased, age of the machine, model, and other information of the machine, part, or service provided. The DBS database may include information regarding machines from one or more manufacturers.

Also, the data regarding machine transactions may be provided from public financial statements that are filed with one or more public agencies. For example, in accordance with the Uniform. Commercial Code (UCC), lessors (secured parties) and lessees (debtors) may make available to the public their equipment leasing information in the form of a financial statement in order to record and protect a secured party's interest in collateral offered by a debtor for a loan. The financial statements are made public and therefore gives the public notice of, e.g., the debtor-secured party relationship and the collateral involved. Financial statements are also filed and made public for sales, refinancing, and other transactions relating to new and used machines and engines. Thus, the machine transactions database 30 may include a UCC database that includes information from these public financial statements, such as information regarding the buyer, seller, lessor, lessee, manufacturer, model, and other information of the machine or engine. The UCC database may include information regarding machines from multiple manufacturers.

The construction projects database 32 may include data regarding construction projects and/or other projects, such as road projects, building projects (e.g., office, retail, industrial, mining, etc.), etc. The projects identified in the construction projects database 32 may be completed, currently in progress, or in a planning state. The data may include information regarding the construction project, such as the size of the area of construction, work plans (e.g., blueprints, specifications, etc.) for the construction project, and financial information regarding the construction project. The data may also include information regarding machines used in the past, currently in use, and/or planned for use for the construction project, such as the machine manufacturer, model, etc. The data may also include bidding information associated with the construction projects, such as identification information regarding contractors and other entities who have placed bids (including losing and/or winning bids) to provide work on the construction projects, the status of the bids (e.g., pending, rejected, lowest, won, etc.), and financial information associated with the bid. The data may include information regarding construction projects open for bidding, that are currently receiving bids, and that are closed for bidding. For example, the construction projects database 32 may include information from FW Dodge Reports and/or other services that provide similar information.

The fleet composition database 34 may include data regarding a fleet or group of machines owned, leased, or otherwise associated with a particular customer. For example, the fleet composition database 34 may be a product tracking database owned and/or operated by a machine manufacturer. The fleet composition database 34 may include information input by the machine manufacturer and/or other entities to track the location and status of machines made by the manufacturer and/or other manufacturers, such as data on buyers, sellers, lessors, lessees, dates sold/leased, age of the machines, locations of the machines, models, whether the machines were purchased new or used, and other information of the machine or part. The fleet composition database 34 may also identify a predicted time and/or frequency for replacement of particular parts included in the machines and/or for performing services (e.g., maintenance) for particular machines and/or parts in the machines. The prediction may be made based on, e.g., the type and/or model of the machines. The “type” of the machine may relate, for example, to whether the machine is new or used, and/or may relate to the operations performed by the machine, e.g., an excavator, a bulldozer, a loader, a backhoe, a dump truck., a harvesting machine, etc.

Thus, the fleet composition database 34 may identify current and/or prior customers based on the entities identified in the fleet composition database 34, e.g., as buyers, sellers, lessors, lessees, etc. The fleet composition database 34 may provide information regarding the machines that are currently owned and/or leased by a particular customer, and/or the machines that were previously owned and/or leased by the particular customer.

### INDUSTRIAL APPLICABILITY

The components described above may constitute the system 10 for creating customer profiles. The customer profiles may be useful in applications such as, for example, identifying potential customers, evaluating behavior of existing, prior, and/or potential customers, predicting a likelihood to buy, sell, or perform other machine transactions, and/or any other applications in which an accurate customer profile is desired. With reference to FIG. 2, the operation of the system for creating customer profiles will now be explained.

In an exemplary embodiment, the computer system 12 retrieves data from the machine transactions database 30, the construction projects database 32, and/or the fleet composition database 34 (step 40). The data may include any of the data or information described above.

The data retrieved from the databases 30, 32, 34 may be extracted, cleansed, and/or integrated together (step 42). The parties identified in the databases 30, 32, 34 may be identified in each database 30, 32, 34 using different names. For example, a company named “X Corp.” may be identified in one database as “X Co.”, in another database as “X Corporation”, and in yet another database as “X Corp.” Thus, after retrieving the data, the computer system 12 may perform an algorithm that extracts, cleanses, and/or integrates the retrieved data in order to group together the data regarding a particular customer under a single name. Thus, the computer system 12 may integrate information identifying “X Co.”, “X Corporation”, “X Corp.”, and other similar names identified as a buyer, seller, lessor, lessee, etc., in the machine transactions database 30, as a bidder in the construction projects database 32, and/or as a buyer, seller, lessor, lessee, etc., in the fleet composition database 34. As a result, each of the databases 30, 32, 34 may provide data for various customers, and the computer system 12 may organize the data to associate the relevant information with the respective customers, while taking into account possible variations in the names of the respective customers. The computer system 12 therefore recognizes when information relates to a particular customer. As a result, the system 10 may provide a consolidated, master database that incorporates information from multiple databases operated by separate entities and including different types of information. The system 10 therefore provides a more complete picture of the customers' activity.

The computer system 12 may evaluate the data for a particular customer based on one or more business metrics (step 44). Alternatively, a user using the computer system 12 may perform this step using the data retrieved in step 40 and/or extracted, cleansed, and/or integrated in step 42. The evaluation may be based on the data retrieved from databases 30, 32, 34. The business metrics may be used to evaluate the customer's propensity to buy, sell, rent, purchase services, purchase parts, etc. For example, the business metrics may include determining a quantity of transactions, e.g., how many machines, parts, and/or services that the customer has bought, sold, rented, etc. The business metrics may also include determining a frequency of transactions, e.g., how often the customer buys, sells, rents, etc., machines, parts, and/or services. The business metrics may also include when the customer performed its last transaction or when the customer last bought, sold, rented, etc., a machine, part, and/or service. The business metrics may also include determining other information about the machines bought, sold, or rented by the customer, such as the manufacturers, types, and/or models of the machines. Information regarding prior machine transactions, e.g., provided in the machine transactions database 30, information regarding construction projects, e.g., provided in the construction projects database 32, and/or information regarding current and previous fleet composition, e.g., provided in the fleet composition database 34, may be evaluated in connection with the determinations described above.

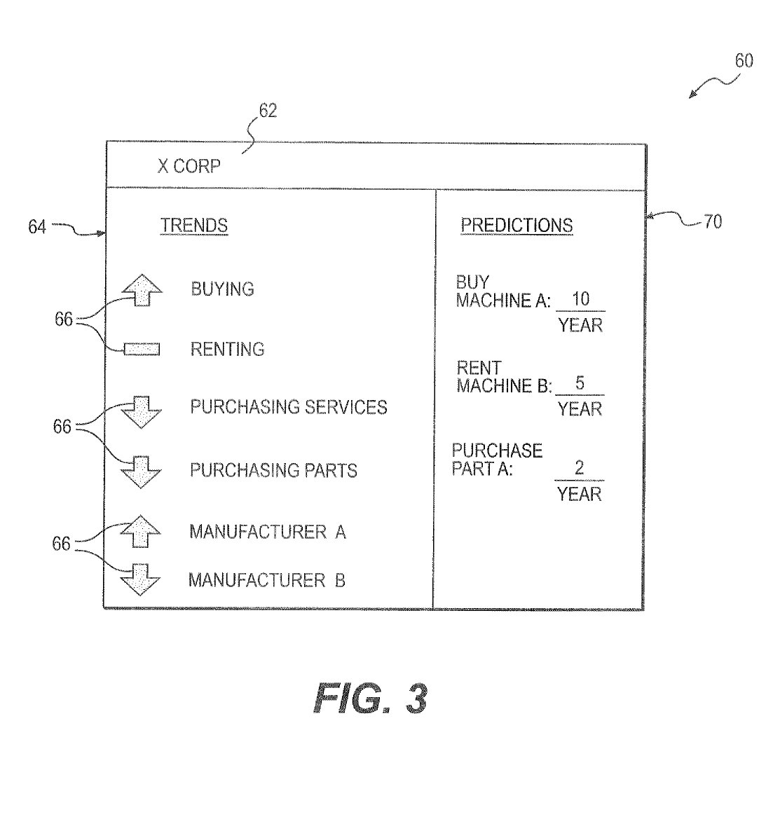

The computer system 12 may also assign one or more indicators 66 (FIG. 3) to the particular customer based on the evaluation (step 46). For example, the evaluation may indicate that the customer is “trending up” (e.g., increasing the quantity and/or frequency of machine transactions), “trending down” (e.g., decreasing the quantity and/or frequency of machine transactions), or staying level (e.g., keeping the quantity and/or frequency of machine transactions relatively the same). As shown in FIG. 3, the indicators 66 used to indicate trending up, trending down, and staying level may include, for example, an up arrow, a down arrow, and a dash, respectively. The trends may be determined based, for example, on one or more of the following: a change in the quantity and/or frequency of machine transactions, a comparison to the quantity and/or frequency of machine transactions of other customers, etc.

In an exemplary embodiment, to determine the trends, the evaluation may involve assigning a numerical value or icon corresponding to the results of the determinations described above in step 44. The results of the determinations may be made manually by an user (e.g., after the user has reviewed and evaluated the data associated with the customer in steps 40, 42, and 44) or automatically by the computer system 12. For example, to determine a numerical value relating to how much a customer is buying a machine of type A, the computer system 12 may determine a first value indicating an average yearly quantity of machines of type A bought by the customer within a historical time period (e.g., between 5 and 10 years ago) and a second value indicating an average yearly quantity of machines of type A bought by the customer within a more recent time period (e.g., within the last 5 years). The ratio of the second value to the first value may be determined, and normalized to within a common scale that ranges between 0 (corresponding to a relatively small ratio) and 100 (correspond to a relatively large ratio). For example, a value of 0-33 in the common scale may indicate a downward trend, a value of 34-66 may indicate staying level, and a value of 67-100 may indicate an upward trend. As a result, the normalized value may be used to determine whether the trend is trending upward or downward, or staying level, and may be used to assign the indicators 66 described above. Alternatively, the numerical value may be determined by graphing average quantities of machines of type A that were bought per year (or other period of time), determining a slope of the graph, and normalizing the slope to within a common scale ranging between 0 and 100.

The trends may be determined with regard to performing certain types of transactions. For example, the evaluation may indicate that the customer is trending up with respect to buying machines, staying level with respect to renting machines, trending down with respect to purchasing services, or trending down with respect to purchasing parts, as shown in FIG. 3. Also, trends may be determined with regard to transactions relating to a certain type or model of machines, made from a particular manufacturer, etc. For example, the evaluation may indicate that the customer is trending up with respect to purchasing machines of model A, trending down with respect to rentals of machines of model B, trending up with respect to purchasing/renting machines made by manufacturer A (as shown in FIG. 3), and trending down with respect to purchasing/renting machines made by its manufacturer B (as shown in FIG. 3). Trends may also be determined regarding purchasing/renting of new machines or purchasing/renting of used machines.

The computer system 12 may also predict a future transaction associated with a particular customer (step 48). Alternatively, a user using the computer system 12 may perform this step. For example, a frequency and/or quantity of machine transactions may be predicted. The prediction may indicate a number of machines of a certain type or model being bought, sold, rented, serviced, and/or having a part replaced within a time period (e.g, within the next three months, within the next year, within the next five years, etc.) or at a particular frequency (e.g., monthly, yearly, etc.).

The predictions may be made based on the data retrieved from databases 30, 32, 34 in steps 40 and 42, and/or the evaluation of the data based on the business metrics in step 44. For example, if the evaluation in step 44 indicates that the customer is trending up with respect to purchasing machines of model A, then the computer system 12 may also predict that the customer will purchase a particular number of machines of model A within a particular time period. The number of machines and the length of the time period may be predicted based on the numerical score and/or indicator assigned in step 46. The computer system 12 may also make other predictions based on other trends indicated for the customer.

The predictions may be based directly on the data retrieved from databases 30, 32, 34. For example, the construction projects database 32 may be used to identify potential customers and machines needed to complete the respective construction projects. Contractors who win bids to work on construction projects generally need machines to complete those construction projects. Information regarding the work to be completed for the construction project (e.g., based on the plans or specifications provided by the construction projects database 32) may also be used to identify machines (e.g., quantity, type, model, etc.) that the potential customer may buy, rent, purchase parts/services, etc. Thus, if the data retrieved from the construction projects database 32 indicates that the customer was successful or is likely to succeed in bidding for a particular construction project, then the computer system 12 may predict the machines (quantity, type, model, etc.) that the customer will use for the construction project, e.g., based on prior quantity, type, model, etc., of machines bought and/or rented by the customer (e.g., determined using information from the machine transactions database 30 and/or the fleet composition database 34), the type of work involved in the construction project, etc. Then, the computer system 12 may predict the customer's future machine transactions for completing the construction project.

Also, information regarding prior machine transactions, e.g., provided in the machine transactions database 30, and/or information regarding current and previous fleet composition, e.g., provided in the fleet composition database 34, may also be used to predict the machines (quantity, type, model, etc.) that a customer will use in the future and other machine transactions that the customer will perform.

Then, the computer system 12 may create and display a profile for a particular customer (step 50). The customer profile may include any information described above. For example, FIG. 3 shows an exemplary customer profile for customer “X Corp.” At the top of the profile, the customer's name 62 may be indicated. The profile 60 may indicate one or more trends 64 associated with the customer. The trends 64 may include the trends described above and may also include the respective indicators 66 described above.

For example, as shown in FIG. 3, the trends 64 may include trends relating to particular types of machine transactions, e.g., buying machines, renting machines, purchasing services, purchasing parts, etc. The trends 64 may also include trends relating to particular types or models of machines, parts, and/or services, e.g., buying machines of particular types, renting machines of particular types, buying replacement parts of particular types, purchasing services of particular types, etc. The trends 64 may also include trends relating to a preference of one type of transaction over another, e.g., buying used machines rather than new machines, buying machines rather than renting machines, etc. Also, as shown in FIG. 3, the trends 64 may include trends relating to using (e.g., buying, renting, etc.) machines made by particular manufacturers. The trends 64 may also include a combination of one or more factors described above e.g., a trend relating a buying machines of a particular type from a particular manufacturer.

The profile 60 may also indicate the predictions 70 associated with the customer, as determined in step 48. For example, the predictions 70 may include predictions relating to particular types of machine transactions, buying a certain quantity of machines, renting a certain quantity of machines, purchasing a certain amount of services, purchasing a certain quantity of parts, etc., within a certain time period. As shown in FIG. 3, the predictions 70 may include predictions relating to particular types or models of machines, parts, and/or services, e.g., buying a certain quantity of machines of particular types, renting a certain quantity of machines of particular types, buying a certain quantity of replacement parts of particular types, purchasing a certain amount of services of particular types, etc., within a certain time period. The predictions 70 may also include predictions relating to using (e.g., buying, renting, etc.) machines made by particular manufacturers. The predictions 70 may also include a combination of one or more factors described above, e.g., a prediction relating to buying machines of a particular type from a particular manufacturer.

As a result, the profile 60 may be a complete customer characteristic profile that indicates trends and/or predictions that may be determined based on a more complete picture of past, present, and future activity obtained from the three databases 30, 32, 34 described above. The profile 60 provides manufacturers, dealers, and other entities with a deeper understanding of customers and their behavior, and allows for more effective targeted marketing and sales efforts. Machine manufacturers, dealers, and other business entities may use the profiles 60 to identify particular customers and/or areas of business on which to focus to target specific types of marketing to prior, prospective, and/or existing customers.

For example, a machine manufacturer may use the computer system 12 to determine which customers are trending up with respect to using machines made by that manufacturer, and may compare the trend for that manufacturer to the trends associated with the manufacturer's competitors. Therefore, this comparison may indicate customers who are more loyal to the manufacturer, customers who are defecting towards competitors, and/or customers who are going out of business (e.g., because they are buying and/or renting less in general). The machine manufacturer may also target the identified customers by focusing marketing to that customer on the types of machine transactions, types of machines, and/or other areas of business, that are trending up for that customer. As a result, the system 10 for creating customer profiles may be used to identify potential customers and areas of business that would he more likely to interest the customer.

The machine manufacturer may analyze the data regarding a particular customer to determine which business areas to focus its marketing to that customer. For example, if the trends 64 and/or predictions 70 indicate that, for a particular customer (e.g., a prior, current, or potential customer), that customer is more likely to buy machines rather than rent machines, the machine manufacturer may decide to focus its marketing more towards appealing to the customer to buy machines. Also, if the trends 64 and/or predictions 70 indicate that a particular customer rarely rents machines, then the machine manufacturer may decide to focus its marketing to business areas other than rentals.

The system 10 may also be used to determine which customers are located within close proximity to a particular dealer, and to determine areas of business that interest the identified customers, based on the trends 64 and/or predictions 70. As a result, the dealer may be provided with insight into the particular customers located close to the dealer (e.g., within the dealer's territory).

Methods and systems consistent with the disclosed embodiments may relate to a business environment including one or more groups of business entities, including product manufacturers, dealers, and customers. It should be noted, however, that applications of the disclosed embodiments are not limited to any particular type of business entity.

It will be apparent to those skilled in the art that various modifications and variations can be made to the methods and systems described above. Other embodiments will be apparent to those skilled in the art from consideration of the specification and practice of the disclosed methods and systems. It is intended that the specification and examples be considered as exemplary only, with a true scope being indicated by the following claims and their equivalents.

1. A system for creating a customer profile, the system comprising:
at least one computer system configured to:
retrieve first business information regarding a customer from at least one first database including data regarding machine transactions;
retrieve second business information regarding the customer from at least one second database including data regarding construction projects, the data regarding construction projects including business information regarding bids for construction projects;
predict a future transaction by the customer based on at least the business information regarding bids for construction projects;
retrieve third business information regarding the customer from at least one third database including data regarding fleet composition; and
create the profile of the customer based on the retrieved first, second, and third business information, and the predicted future transaction.

2. The system of claim 1, wherein the at least one first database includes invoice information input by a plurality of machine dealers.

3. The system of claim 1, wherein the machine transactions include sales of machines, rentals of machines, sales of parts, and sales of services.

4. The system of claim 1, wherein the business information regarding bids for construction projects includes business information regarding at least one of pending or completed bids for construction projects.

5. The system of claim 1, wherein the at least one third database includes a product tracking database associated with at least one machine manufacturer.

6. The system of claim 1, wherein the data regarding fleet composition identifies at least one of types or models of machines included in the customer's fleet.

7. The system of claim 1, wherein the at least one computer system is further configured to receive the first, second, and third business information and recognize when the first, second, and third business information relates to the customer.

8. The system of claim 1, wherein the at least one computer system is further configured to predict the future transaction by the customer further based on at least one of the first business information or the third business information.

9. (canceled)

10. The system of claim 1, wherein the at least one computer system is further configured to:
evaluate at least one of the retrieved first, second, and third business information based on at least one business metric; and
assign at least one indicator to the customer based on the evaluation, the profile of the customer being created further based on the at least one indicator.

11. The system of claim 10, wherein the at least one indicator indicates a trend relating to buying used machines rather than new machines, or a trend relating to renting rather than renting buying.

12. A method for creating a customer profile using at least one computer system, the method comprising:
retrieving, using the at least one computer system, first business information regarding a customer from at least one first database including data regarding machine transactions;
retrieving, using the at least one computer system, second business information regarding the customer from at least one second database including data regarding construction projects;
retrieving, using the at least one computer system, third business information regarding the customer from at least one third database including data regarding fleet composition; and
predicting at least one future transaction by the customer based on at least one of the first business information, the second business information, or the third business information, wherein the at least one future transaction includes buying or renting at least one of a particular type of machine or a machine from a particular manufacturer;
creating, using the at least one computer system, the profile of the customer based on the retrieved first, second, and third business information and the at least one future transaction.

13. (canceled)

14. (canceled)

15. The method of claim 12, further comprising:
evaluating at least one of the retrieved first, second, and third business information based on at least one business metric; and
assigning at least one indicator to the customer based on the evaluation, the profile of the customer being created further based on the at least one indicator.

16. The method of claim 15, wherein the at least one business metric includes determining, for the customer, at least one of a quantity of transactions, a frequency of transactions, or when a last transaction occurred.

17. A non-transitory computer readable medium for use on at least one computer system containing computer-executable programming instructions for performing a method for creating a customer profile, the method comprising:
retrieving business information regarding a customer from at least one database including at least one of data regarding machine transactions, data regarding construction projects, or data regarding fleet composition;
evaluating the retrieved business information based on at least one business metric;
assigning at least one indicator to the customer based on the evaluation, the at least one indicator indicating a trend relating to at least one of buying machines or renting machines;
predicting a future transaction by the customer based on the determined business information;
creating the profile of the customer based on the determined business information, the at least one indicator, and the predicted future transaction.

18. (canceled)

19. The non-transitory computer readable medium of claim 17, wherein the future transaction relates to at least one of buying or renting machines from a particular manufacturer.

20. (canceled)

21. The system of claim 1, wherein the future transaction relates to at least one of purchasing a particular service.

22. The system of claim 1, wherein the future transaction relates to purchasing a particular part.

23. The system of claim 10, wherein the at least one indicator indicates a trend relating to at least one of purchasing parts or purchasing services. /

24. The method of claim 15, wherein the at least one indicator indicates a trend relating to at least one of buying or renting a particular type of machine, or buying or renting machines from a particular manufacturer.

25. The non-transitory computer readable medium of claim 17, wherein the at least one indicator indicates a trend relating to buying used machines and the future translation relates to buying used machines.

26. The non-transitory computer readable medium of claim 17, wherein the future translation relates to at least one of buying or renting a particular type of machine.
